(19) United States
(12) Patent Application Publication
(10) Pub. No.: US 2012/0098889 A1
(43) Pub. Date: Apr. 26, 2012

(54) METHOD OF FORMING WATER REPELLING FILM, WATER REPELLING FILM, AND NOZZLE PLATE OF INKJET HEAD

(76) Inventor: Takami ARAKAWA, Ashigarakami-gu (JP)

(21) Appl. No.: 13/279,612

(22) Filed: Oct. 24, 2011

(30) Foreign Application Priority Data
Oct. 25, 2010 (JP) 2010-238987

(51) Int. Cl. B41J 2/135; C09D 183/04; C08F 2/48; C08F 2/46; C08J 7/18

(52) U.S. Cl. 347/45; 427/487; 427/489; 427/515; 524/588

(57) ABSTRACT

A method of forming a water repelling film, includes: a thin film forming step of forming, on a base member, a thin film mainly having Si—O bonds and having hydrophobic substituent groups directly bonded to silicon, using a starting material which is a gas at normal temperature and atmospheric pressure; an irradiation step of irradiating the thin film obtained in the thin film forming step with excitation light in such a manner that the hydrophobic substituent groups are left and OH groups are present in the thin film; and an application step of applying a silane coupling agent onto the thin film obtained in the irradiation step.

### BACKGROUND OF THE INVENTION

1. Field of the Invention

The present invention relates to a method of forming a water repelling film, and in particular to a method of forming a water repelling film which can be suitably provided on a nozzle plate of an inkjet head.

2. Description of the Related Art

In an inkjet head which is used in an inkjet recording apparatus, when ink adheres to the surface of the nozzle plate, the ink droplets ejected from the nozzles are affected thereby and variation may occur in the ejection direction of the ink droplets. When the ink adheres in this way, it is difficult to deposit ink droplets at prescribed positions on the recording medium and this causes deterioration of image quality.

Therefore, in order to improve ejection performance and also to improve maintenance characteristics by preventing the adherence of ink to the surface of the nozzle plate, various methods have been proposed for forming a water repelling film on the surface of the nozzle plate.

One method of providing a water repelling treatment on the surface of the nozzle plate is a method which uses fluorine resin or a monomolecular film containing fluorine. However, if a monomolecular film is used, then it is difficult to form a film completely over the nozzle surface, due to the effects of particles, and the like, which become attached to the surface during the manufacture of the inkjet head. Furthermore, a monomolecular film containing fluorine has high electronegativity and therefore it is difficult to arrange adjacent molecules with high density. In other words, a monomolecular film can only be formed at low density and it has been difficult to achieve sufficient water repelling performance.

Furthermore, a water repelling film in an inkjet head may peel away due to maintenance such as wiping with a rubber blade, or the like, which may give rise to variation in the ejection direction of the ink droplets. Therefore, a more robust water repelling film is demanded.

Aside from inkjet recording apparatuses, in the field of touch panels, for example, a film substantially the same as that of an inkjet head is used as a film for preventing soiling by finger prints, or the like. However, in this field, in a target device which is touched in the same position at all times, such as a ticket vending machine, there is a possibility that the soiling prevention film peels away and the soiling prevention characteristics decline.

In response to problems of this kind, Japanese Patent Application Publication No. 2005-246707 and Japanese Patent Application Publication No. 2010-30142 describe technology which involves coating of a plasma polymer silicone film that is polymerized by thermally evaporating molecules such as octamethyl trisiloxane, and introducing it into plasma, this film being activated by UV or plasma energy, or the like, to generate OH groups, and a silane coupling type of fluorine material being applied thereto to create strong silane coupling bonds.

However, a plasma polymerization apparatus having a thermal evaporator as described in Japanese Patent Application Publication No. 2005-246707 and Japanese Patent Application Publication No. 2010-30142 is very expensive indeed, and hence there is a possibility that the costs involved in manufacturing a water repelling film, or the like, on an inkjet head become too high.

### SUMMARY OF THE INVENTION

The present invention has been contrived in view of these circumstances, an object thereof being to provide a method of forming a water repelling film whereby a water repelling film can be manufactured inexpensively, without requiring a plasma polymerization apparatus including an expensive thermal evaporator.

In order to achieve an aforementioned object, one aspect of the present invention is directed to a method of forming a water repelling film, the method comprising: a thin film forming step of forming, on a base member, a thin film mainly having Si—O bonds and having hydrophobic substituent groups directly bonded to silicon, using a starting material which is a gas at normal temperature and atmospheric pressure; an irradiation step of irradiating the thin film obtained in the thin film forming step with excitation light in such a manner that the hydrophobic substituent groups are left and OH groups are present in the thin film; and an application step of applying a silane coupling agent onto the thin film obtained in the irradiation step. If using a starting material which is a gas at normal temperature and atmospheric pressure, desirably, the thin film forming step is carried out by cat-CVD or by plasma CVD.

Furthermore, in order to achieve an aforementioned object, another aspect of the present invention is directed to a method of forming a water repelling film, the method comprising: a thin film forming step of forming, on a base member, a thin film mainly having Si—O bonds and having hydrophobic substituent groups directly bonded to silicon, by applying the thin film onto the base member followed by calcination; an irradiation step of irradiating the thin film obtained in the thin film forming step with excitation light in such a manner that the hydrophobic substituent groups are left and OH groups are present in the thin film; and an application step of applying a silane coupling agent onto the thin film obtained in the to irradiation step.

By means of the method of forming a water repelling film described above, it is possible to provide a method of forming a water repelling film whereby a water repelling film can be manufactured inexpensively, without requiring a plasma polymerization apparatus including an expensive thermal evaporator.

Since the speed of thermal evaporation by a thermal evaporator is instable, then aspects of the present invention which do not require thermal evaporation are favorable in terms of the reproducibility of film formation also.

Furthermore, in this water repelling film, the OH groups create strong bonds with the silane coupling water repelling material, due to the underlying siloxane film which retains hydrophobic substituent groups, and since these hydrophobic substituent groups impart ink resisting properties, then it is also possible to impart ink resistance in comparison with a conventional SiO₂ material.

Desirably, the hydrophobic substituent group is a methyl group. This group may be a hydrophobic group having a benzene ring, such as an alkyl group or phenyl group, but if the group is CH₃, then the thin film forming step can be carried out easily and inexpensively.

Furthermore, the substance (material) of the base member for forming the thin film described above is desirably any one of silicon, glass, metal, ceramic, or polymer film. An inexpensive water repelling film which is strong and has good reproducibility can be formed, based on any one of silicon, glass, metal, ceramic, or polymer film.

Furthermore, the excitation light may be ultraviolet light or plasma. When an ultraviolet or plasma strikes the thin film including Si—O bonds, as an excitation light, Si—OH groups are generated.

Furthermore, a water repelling film formed by the above can be suitably provided on a nozzle plate of an inkjet head. Since the water repelling film does not peel away and ink can be prevented from adhering to the surface of the nozzle plate, then it is possible to improve ejection performance.

According to a method of forming a water repelling film, a water repelling film, and a nozzle plate of an inkjet head according to the present invention, it is possible to achieve inexpensive manufacture without requiring a plasma polymerization apparatus having an expensive thermal evaporator.

### BRIEF DESCRIPTION OF THE DRAWINGS

A preferred embodiment of this invention as well as other objects and benefits thereof, will be explained in the following with reference to the accompanying drawings, in which like reference characters designate the same or similar parts throughout the figures and wherein:

FIG. 1 is a general schematic drawing showing a general view of an inkjet recording apparatus;

FIGS. 2A and 2B are plan view perspective diagrams showing examples of the structure of an inkjet head;

FIG. 3 is a cross-sectional diagram along line III-III in FIG. 2A; and

FIG. 4 is a schematic drawing of a chemical structure of a molecule constituting a water repelling film relating to an embodiment of the present invention.

### DESCRIPTION OF THE PREFERRED EMBODIMENTS

### General Composition of Inkjet Recording Apparatus

Firstly, a nozzle plate and an inkjet recording apparatus including a nozzle plate are described as an example of application of a water repelling film manufactured by a method of manufacturing a water repelling film according to an embodiment of the present invention.

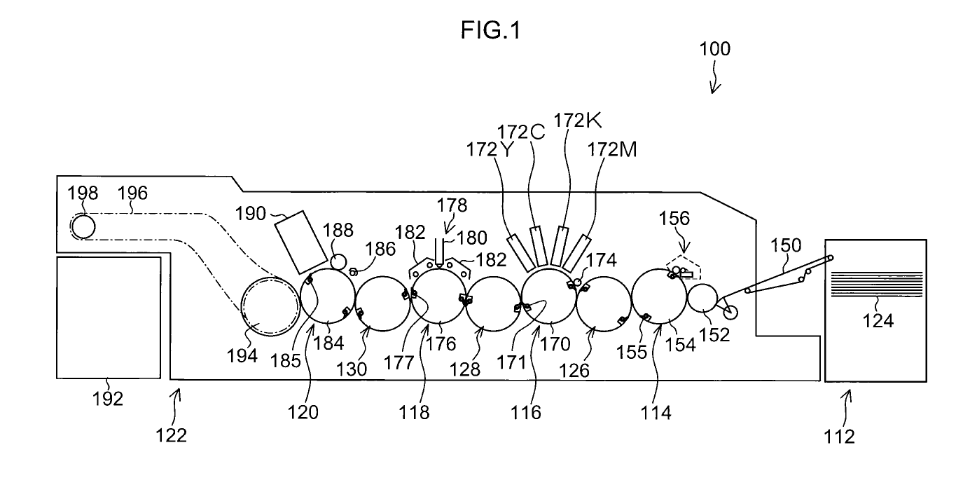

FIG. 1 is a schematic drawing of an inkjet recording apparatus. This inkjet recording apparatus 100 is an inkjet recording apparatus using a pressure drum direct image formation method which forms a desired color image by ejecting droplets of inks of a plurality of colors from inkjet heads 172M, 172K, 172C and 172Y onto a recording medium 124 (also called “paper” below for the sake of convenience) held on a pressure drum (image formation drum 170) of an image formation unit 116. The inkjet recording apparatus 100 is an image forming apparatus of an on-demand type employing a two-liquid reaction (aggregation) method in which an image is formed on a recording medium 124 by depositing a treatment liquid (here, an aggregating treatment liquid) on a recording medium 124 before ejecting droplets of ink, and causing the treatment liquid and ink liquid to react together.

As shown in FIG. 1, the inkjet recording apparatus 100 principally includes a paper feed unit 112, a treatment liquid deposition unit 114, an image formation unit 116, a drying unit 118, a fixing unit 120 and a paper output unit 122.

### Paper Supply Unit

The paper supply unit 112 is a mechanism for supplying a recording medium 124 to the treatment liquid deposition unit 114, and recording media 124, which are cut sheet paper, are stacked in the paper supply unit 112. A paper supply tray 150 is provided with the paper supply unit 112, and the recording medium 124 is supplied one sheet at a time to the treatment liquid deposition unit 114 from the paper supply tray 150.

### Treatment Liquid Deposition Unit

The treatment liquid deposition unit 114 is a mechanism which deposits treatment liquid onto a recording surface of the recording medium 124. The treatment liquid includes a coloring material aggregating agent which aggregates the coloring material (in the present embodiment, the pigment) in the ink deposited by the image formation unit 116, and the separation of the ink into the coloring material and the solvent is promoted due to the treatment liquid and the ink making contact with each other.

As shown in FIG. 1, the treatment liquid deposition unit 114 includes a paper supply drum 152, a treatment liquid drum 154 and a treatment liquid application apparatus 156. The treatment liquid drum 154 is a drum which holds the recording medium 124 and conveys the medium so as to rotate. The treatment liquid drum 154 includes a hook-shaped gripping device (gripper) 155 provided on the outer circumferential surface thereof, and is devised in such a manner that the leading end of the recording medium 124 can be held by gripping the recording medium 124 between the hook of the holding device 155 and the circumferential surface of the treatment liquid drum 154.

A treatment liquid application apparatus 156 is provided opposing the circumferential surface of the treatment liquid drum 154, to the outside of the drum. The treatment liquid application apparatus 156 includes a treatment liquid vessel in which treatment liquid is stored, an anilox roller which is partially immersed in the treatment liquid in the treatment liquid vessel, and a rubber roller which transfers a dosed amount of the treatment liquid to the recording medium 124, by being pressed against the anilox roller and the recording medium 124 on the treatment liquid drum 154. According to this treatment liquid application apparatus 156, it is possible to apply treatment liquid to the recording medium 124 while dosing the amount of the treatment liquid.

The recording medium 124 onto which treatment liquid has been deposited by the treatment liquid deposition unit 114 is transferred from the treatment liquid drum 154 to the image formation drum 170 of the image formation unit 116 via the intermediate conveyance unit 126.

### Image Formation Unit

The image formation unit 116 includes an image formation drum 170 (second conveyance member), a paper pressing roller 174, and inkjet heads 172M, 172K, 172C and 172Y. Similarly to the treatment liquid drum 154, the image formation drum 170 includes a hook-shaped holding device (gripper) 171 on the outer circumferential surface of the drum. The recording medium 124 held on the image formation drum 170 is conveyed with the recording surface thereof facing to the outer side, and ink is deposited onto this recording surface from the inkjet heads 172M, 172K, 172C and 172Y.

The inkjet heads 172M, 172K, 172C and 172Y are desirably full-line type inkjet recording heads (inkjet heads) having a length corresponding to the maximum width of the image forming region on the recording medium 124. A nozzle row of nozzles for ejecting ink arranged throughout the whole width of the image forming region is formed in the ink ejection surface of each head. The inkjet heads 172M, 172K, 172Y and 172Y are each disposed so as to extend in a direction perpendicular to the conveyance direction of the recording medium 124 (the direction of rotation of the image formation drum 170).

When droplets of the corresponding colored ink are ejected from the inkjet heads 172M, 172K, 172C and 172Y toward the recording surface of the recording medium 124 which is held tightly on the image formation drum 170, the ink makes contact with the treatment liquid which has previously been deposited onto the recording surface by the treatment liquid deposition unit 114, the coloring material (pigment) dispersed in the ink is aggregated, and a coloring material aggregate is thereby formed. By this means, flowing of coloring material, and the like, on the recording medium 124 is prevented and an image is formed on the recording surface of the recording medium 124.

The recording medium 124 onto which an image has been formed in the image formation unit 116 is transferred from the image formation drum 170 to the drying drum 176 of the drying unit 118 via the intermediate conveyance unit 128.

### Drying Unit

The drying unit 118 is a mechanism which dries the water content contained in the solvent which has been separated by the action of aggregating the coloring material, and as shown in FIG. 1, includes a drying drum 176 and a solvent drying apparatus 178.

Similarly to the treatment liquid drum 154, the drying drum 176 includes a hook-shaped holding device (gripper) 177 provided on the outer circumferential surface of the drum, in such a manner that the leading end of the recording medium 124 can be held by the holding device 177.

The solvent drying apparatus 178 is disposed in a position opposing the outer circumferential surface of the drying drum 176, and includes a plurality of halogen heaters 180 and hot air spraying nozzles 182 disposed respectively between the halogen heaters 180.

The recording medium 124 on which the drying process has been carried out in the drying unit 118 is transferred from the drying drum 176 to the fixing drum 184 of the fixing unit 120 via the intermediate conveyance unit 130.

### Fixing Unit

The fixing unit 120 includes a fixing drum 184, a halogen heater 186, a fixing roller 188 and an in-line sensor 190. Similarly to the treatment liquid drum 154, the fixing drum 184 includes a hook-shaped holding device (gripper) 185 provided on the outer circumferential surface of the drum, in such a manner that the leading end of the recording medium 124 can be held by the holding device 185.

By means of the rotation of the fixing drum 184, the recording medium 124 is conveyed with the recording surface facing to the outer side, and preliminary heating by the halogen heater 186, a fixing process by the fixing roller 188 and inspection by the in-line sensor 190 are carried out in respect of the recording surface.

According to the fixing unit 120, thermoplastic resin fine particles in the thin image layer formed by the drying unit 118 are heated, pressurized and melted by the fixing roller 188, and hence the image layer can be fixed to the recording medium 124. Furthermore, by setting the surface temperature of the fixing drum 184 to not less than 50° C., drying is promoted by heating the recording medium 124 held on the outer circumferential surface of the fixing drum 184 from the rear surface, and therefore breaking of the image during fixing can be prevented, and furthermore, the strength of the image can be increased by the effects of the increased temperature of the image.

Moreover, in cases where an ultraviolet-curable monomer is included in the ink, after the water has been evaporated off sufficiently in the drying unit, the image is irradiated with ultraviolet light by a fixing unit including an ultraviolet irradiation lamp, thereby curing and polymerizing the ultraviolet-curable monomer and making it possible to improve the strength of the image.

### Paper Output Unit

As shown in FIG. 1, a paper output unit 122 is provided subsequently to the fixing unit 120. The paper output unit 122 includes an output tray 192, and a transfer drum 194, a conveyance belt 196 and a tensioning roller 198 are provided between the output tray 192 and the fixing drum 184 of the fixing unit 120 so as to oppose same. The recording medium 124 is sent to the conveyance belt 196 by the transfer drum 194 and output to the output tray 192.

Furthermore, although not shown in FIG. 1, the inkjet recording apparatus 100 according to the present embodiment includes, in addition to the composition described above, an ink storing and loading unit which supplies ink to the inkjet heads 172M, 172K, 172C and 172Y, and a device which supplies treatment liquid to the treatment liquid deposition unit 114, as well as including a head maintenance unit which carries out cleaning (nozzle surface wiping, purging, nozzle suctioning, and the like) of the inkjet heads 172M, 172K, 172C and 172Y, a position determination sensor which determines the position of the recording medium 124 in the paper conveyance path, a temperature sensor which determines the temperature of the respective units of the apparatus, and the like.

In FIG. 1, an inkjet recording apparatus based on a drum conveyance system is described, but the present invention is not limited to this and can also be used in an inkjet recording apparatus based on a belt conveyance system, or the like.

### Structure of Inkjet Head

Next, the structure of inkjet heads 172M, 172K, 172C and 172Y is described. Here, the respective inkjet heads 172M, 172K, 172C and 172Y have the same structure, and a reference numeral 250 is hereinafter designated to any of the heads.

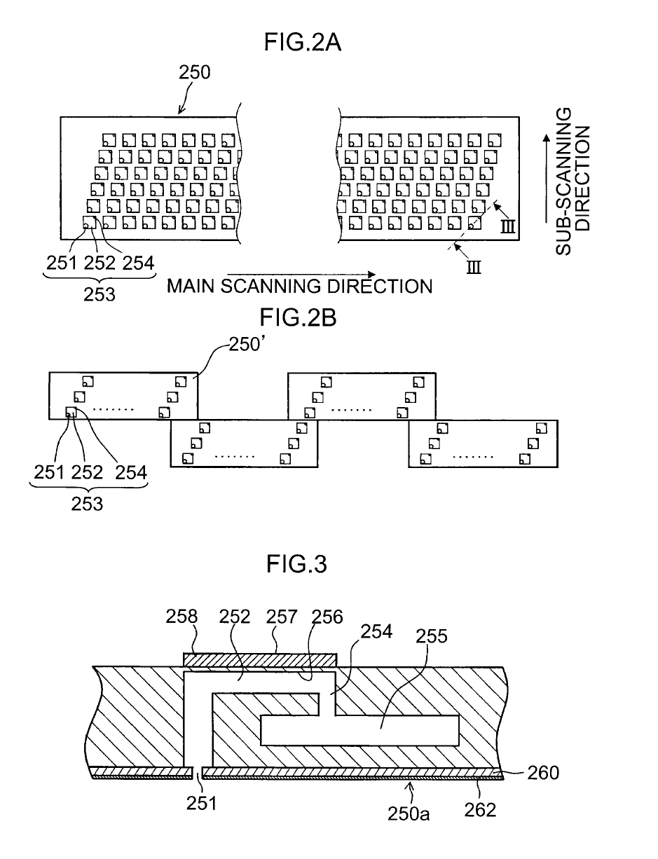

FIG. 2A is a plan view perspective drawing showing an example of a structure of an inkjet head 250 and FIG. 2B is a plan view perspective drawing showing a further example of a structure of an inkjet head 250. FIG. 3 is a cross-sectional diagram showing the composition of an ink chamber unit (a cross-sectional diagram along line III-III in FIG. 2A).

In order to achieve a high density of the dot pitch formed onto the surface of the recording paper, it is necessary to achieve a high density of the nozzle pitch in the inkjet head 250. As shown in FIG. 2A, the inkjet head 250 according to the present embodiment has a structure in which a plurality of ink chamber units 253 are arranged in a staggered matrix configuration (two-dimensional configuration), each ink chamber unit 253 being constituted by a nozzle 251 which is an ink droplet ejection aperture and a pressure chamber 252 corresponding to the nozzle 251, and the like. Accordingly, a high density is achieved in the effective nozzle pitch (namely, the projected nozzle pitch) projected to an alignment in the lengthwise direction of the head (the main scanning direction which is perpendicular to the paper conveyance direction).

An embodiment constituting one or more nozzle rows covering a length corresponding to the full width of the recording medium 124 in a direction substantially perpendicular to the paper conveyance direction is not limited to the present example. For example, instead of the composition in FIG. 2A, as shown in FIG. 2B, a line head having nozzle rows of a length corresponding to the entire width of the recording medium 124 can be formed by arranging and combining, in a staggered matrix, short head blocks (head chips) 250′ each having a plurality of nozzles 251 arrayed in a two-dimensional fashion. Furthermore, although not shown in the drawings, it is also possible to form a line head by aligning short heads in a row.

As shown in FIG. 3, the nozzles 251 are formed in a nozzle plate 260 which constitutes an ink ejection surface 250a of the inkjet head 250. The nozzle plate 260 can be made of a silicon material, such as Si, SiO₂, SiN or quartz glass, a metal material such as Al, Fe, Ni, Cu or an alloy of these, an oxide material such as alumina or iron oxide, a carbonaceous material such as carbon black or graphite, or a resin material such as polyimide.

A water repelling film 262 having liquid repelling properties with respect to ink is formed on the surface (ink ejection side surface) of the nozzle plate 260, thereby preventing adherence of ink.

The pressure chambers 252 which are provided to correspond to the nozzles 251 respectively are formed with a substantially square planar shape and a nozzle 251 and a supply port 254 are provided in the respective corner portions on a diagonal of this planar shape. The respective pressure chambers 252 connect with a common flow channel 255 via the supply ports 254. The common flow channel 255 is connected to an ink supply tank (not shown) which forms an ink supply source, and the ink supplied from the ink supply tank is distributed through the common flow channel 255 to the pressure chambers 252.

Piezoelectric elements 258 each having an individual electrode 257 are bonded to the diaphragm 256 which constitutes a ceiling face of the pressure chambers 252 and also serves as a common electrode; and a piezoelectric element 258 is deformed by applying a drive voltage to the individual electrode 257, thereby causing ink to be ejected from the nozzle 251. When ink is ejected, new ink is supplied to the pressure chamber 252 from the common flow channel 255 via the supply port 254.

The arrangement structure of the nozzles is not limited to the example shown in the drawings, and it is also possible to apply various other types of nozzle arrangements, such as an arrangement structure having one nozzle row in the sub-scanning direction.

Furthermore, the invention is not limited to a print method using a line type head, and the present invention may also be applied to a serial method in which printing is performed in the width direction of the paper by employing a short head which is shorter than the length in the width direction (main scanning direction) of the paper and performing a scanning action of the head in the width direction, and after completing one printing action in the width direction, the paper is moved by a prescribed amount in a direction (sub-scanning direction) perpendicular to the width direction, printing in the width direction of the paper is performed on the next print region, and by repeating this operation, printing is performed over the whole surface of the print area of the paper.

### Method of Manufacturing Water Repelling Film

Next, a method of manufacturing the water repelling film 262 described above will be explained.

A method of forming a water repelling film, comprises: a thin film forming step of forming, on a base member, a thin film mainly having Si—O bonds and having hydrophobic substituent groups directly bonded to silicon, using a starting material which is a gas at normal temperature and atmospheric pressure; an irradiation step of irradiating the thin film obtained in the thin film forming step with excitation light in such a manner that the hydrophobic substituent groups are left and OH groups are present in the thin film; and an application step of applying a silane coupling agent onto the thin film obtained in the irradiation step. Preferably, in this case, cat-CVD or plasma CVD is carried out in the thin film forming step.

The method of manufacturing a water repelling film relating to the present embodiment includes: a thin film forming step of forming, on a base member, a thin film mainly having Si—O bonds and having hydrophobic substituent groups directly bonded to silicon, by applying the thin film onto the base member followed by calcination; an irradiation step of irradiating the thin film obtained in the thin film forming step with excitation light in such a manner that the hydrophobic substituent groups are left and OH groups are present in the thin film; and an application step of applying a silane coupling agent to the thin film obtained in the irradiation step.

By means of the method of forming a water repelling film described above, it is possible to provide a method of forming a water repelling film whereby a water repelling film can be manufactured inexpensively, without requiring a plasma polymerization apparatus including an expensive thermal evaporator.

Since the speed of thermal evaporation by a thermal evaporator is instable, then the present embodiment which does not require thermal evaporation is favorable in terms of the reproducibility of film formation also.

Furthermore, in this water repelling film, by employing the underlying siloxane film which retains hydrophobic substituent groups, the OH groups create strong bonds with the silane coupling water repelling material, and since these hydrophobic substituent groups impart ink resisting properties, then it is also possible to enhance ink resistance in comparison with a conventional SiO₂ material.

The respective steps are described below.

### Thin Film Formation Step

The substance (material) of the base member for forming the thin film described above is desirably any one of silicon, glass, metal, ceramic, or polymer film. The present invention is able to form an inexpensive water repelling film which is strong and has good reproducibility, with any one of silicon, glass, metal, ceramic, or polymer film.

Onto a base member, (1) a thin film mainly having Si—O bonds and having hydrophobic substituent groups directly bonded to silicon, is formed using a starting material which is a gas at normal temperature and atmospheric pressure, or (2) a thin film mainly having Si—O bonds and having hydrophobic substituent groups directly bonded to silicon is applied and calcined.

In the case of (1) above, for example, by using a plasma CVD method or a cat-CVD method in which a silane gas, such as monomethyl silane, dimethyl silane, trimethyl silane, tetramethyl silane, or the like, is introduced into plasma, it is possible to manufacture a thin film having an Si—O skeleton and Si-hydrophobic substituent group bonds, in an apparatus which does not require a thermal evaporator. In this way, by using a gas as a starting material, problems such the very high cost of a thermal vaporizer and the instable speed of thermal vaporization are eliminated, and reduced costs and improved reproducibility of the film formation process can be achieved.

A starting material which is a gas at normal temperature means a gas which can be supplied as a starting material without a heating mechanism in a standard laboratory (including gases having a vapor pressure of 1000 Pa or above at 25° C.).

Furthermore, in the case of (2) above, for example, it is possible to manufacture a polyorganosiloxane film less expensively than by plasma polymerization, by using a methyl siloxane material known as MSQ or organic SOG as expressed by the following formula, or a material having a similar structure to these materials, which includes Si—CH₃ bonds and has Si—O bonds as the main component, for example, the commercially available materials, HSG made by Hitachi Chemical Co., Ltd., HOSP made by Honeywell International Inc., or ULKS Ver3 made by ULVAC, Inc., and applying and calcining this material under conditions whereby a Si—O skeleton is formed and Si-hydrophobic substituent group bonds are left.

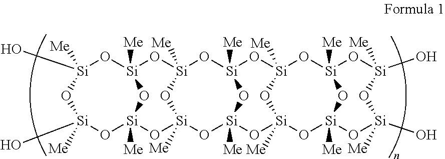

### Irradiation Step

The thin film obtained in the thin film forming step is irradiated with excitation light in such a manner that hydrophobic substituent groups are left and OH groups are present. In other words, hydrophilization is carried out by the excitation light.

In the present invention, the excitation light may be ultraviolet light or plasma. When ultraviolet light or plasma strikes the thin film having Si—O bonds, as an excitation light, then Si—OH groups are generated.

### Application Step

A silane coupling agent is applied onto the thin film obtained in the irradiation step.

The silane coupling agent is a silicon compound represented by YₙSiX₄₋ₙ (n=1, 2, 3). Y includes a relatively inert group, such as an alkyl group, or a reactive group, such as a vinyl group, an amino group, or an epoxy group. X comprises a hydroxyl group on the substrate surface, such as a halogen, a methoxy group, an ethoxy group or an acetoxy group, or a group which can be bonded by condensation with adsorption water. A silane coupling agent is widely used in the manufacture of composite materials comprising an organic material and an inorganic material, such as glass fiber-reinforced plastics, in order to mediate in the bonds between the materials, and if Y is an inert group, such as an alkyl group, then adherence to or abrasion of the modified surface is prevented and characteristics such as sustained gloss, water repelling properties, lubricating properties, and the like, are imparted to the surface. Furthermore, if a reactive group is included, then this is used principally to improve adhesiveness. Moreover, a surface which has been modified by using a fluorine type silane coupling agent having a straight-chain carbon fluoride chain introduced into Y has low surface free energy, like the surface of PTFE (polytetrafluoroethylene), and hence the characteristics, such as water repelling properties, lubricating properties, mold separation, and the like, are improved, and oil-repelling properties are also displayed.

A surface which has been modified by using a fluorine type silane coupling agent having a straight-chain carbon fluoride chain introduced into Y has low surface free energy, like the surface of PTFE (polytetrafluoroethylene), and hence the characteristics, such as water repelling properties, lubricating properties, mold separation, and the like, are improved, and oil-repelling properties are also displayed.

Possible examples of straight chain fluoroalkyl silane of this kind are, for instance: Y═CF₃CH₂CH₂, CF₃(CF₂)₃CH₂CH₂, CF₃(CF₂)₇CH₂CH₂, or the like.

Furthermore, the Y part can use material having a perfluoro polyether (PFPE) group (—CF₂—O—CF₂—).

Moreover, for the silane coupling agent, it is also possible to use a material X₃SiYSiX₃ in which a silane coupling group is bonded on either side, rather than one side only.

Furthermore, it is also possible to use a commercial silane coupling water repelling material, such as Optool made by DAIKIN INDUSTRIES, Ltd., Durasurf made by HARVES Co., Ltd., Novec EGC1720 made by Sumitomo 3M Limited, Fluorolink S-10 made by Solvay Solexis, Nanos made by T&K inc., Saifel KY-100 made by Shin-Etsu Chemical Co., Ltd., Saitop M Type made by Asahi Glass Co., Ltd., or the like.

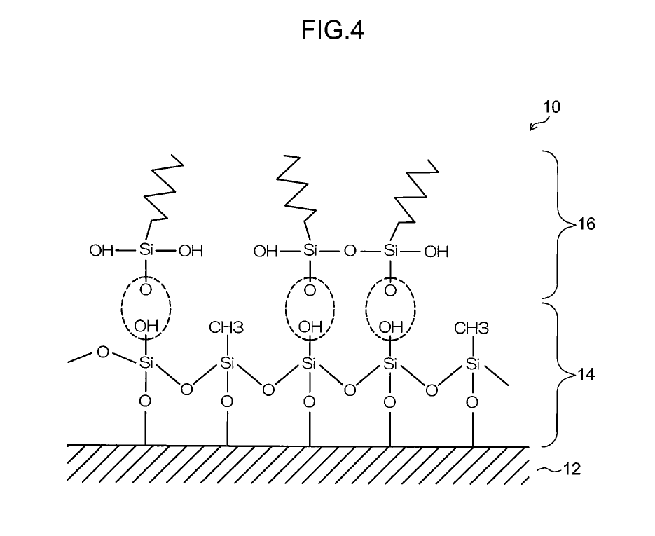

The reactive functional groups in the coupling agent used in order to impart lyophobic properties react with the hydroxyl groups introduced to the surface of the polyorganosiloxane film 14, as shown in FIG. 4, whereby the coupling agent bonds to the surface of the polyorganosiloxane film 14.

Therefore, the larger the amount of hydroxyl groups introduced into the surface of the polyorganosiloxane film, the greater the volume of bonds (bonding rate) of the coupling agent, and the higher the properties corresponding to the type of coupling agent in the film which is obtained (hereinafter, simply called “properties due to the coupling agent”).

However, in general, if the coupling agent has functional groups with relatively high molecular weight, then the properties due to the coupling agent tend to improve, but if the polyorganosiloxane film 14 is processed with a coupling agent of this kind, then physical obstructions occur between functional groups, and a portion of the hydroxyl groups present on the surface are not able to contribute to the reaction with the coupling agent.

Therefore, supposing that substantially all of the hydrophobic groups (in the drawing, CH₃ groups) which are exposed on the surface of the polyorganosiloxane film 14 are substituted with hydroxyl groups, then a film is obtained in which the large number of hydroxyl groups which cannot bond with the coupling agent are left remaining between the coupling agent molecules.

The portion where the hydroxyl groups are left has low resistance with respect to alkalis, and therefore if this film makes prolonged contact with a liquid having alkaline properties (for example, a pigment-based ink, or the like), then the liquid starts to impregnate the film in the portion where the hydroxyl groups are left and the organosiloxane film deteriorates (decomposes). Accordingly, the coupling agent detaches (peels away) from the base member 12 and the properties due to the coupling agent are impaired (eliminated).

On the other hand, as shown in FIG. 4, in the present invention, hydrophobic groups (CH₃ groups) which are exposed on the surface of the polyorganosiloxane film 14 are left to a suitable extent. In other words, hydroxyl groups are introduced sparsely (in a sparse fashion) into the surface of the polyorganosiloxane film 14.

Therefore, even if the polyorganosiloxane film 14 of this kind is processed with a coupling agent 16 having functional groups with a relatively high molecular weight, the coupling agent bonds to the hydroxyl groups of the polyorganosiloxane film 14 without generating physical obstructions between the functional groups.

In this case, the hydroxyl groups present on the surface of the polyorganosiloxane film 14 are practically all consumed in the bonds with the coupling agent, and the hydrophobic groups (CH₃ groups) are exposed on the surface of the polyorganosiloxane film 14 where the coupling agent is not bonded.

In the portions where these hydrophobic groups (CH₃ groups) are present, high alkaline resistance is displayed, and therefore the hydrophobic film 10 according to the present embodiment of the invention has both properties due to the coupling agent and high alkaline resistance due to the polyorganosiloxane.

Therefore, even if the hydrophobic film 10 according to the present embodiment is in prolonged contact with liquid showing alkaline properties, impregnation by alkali is prevented or suppressed, and consequently, the properties due to the coupling agent are maintained over a long period of time.

By means of the method of forming a water repelling film according to the present embodiment of the invention as described above, it is possible to provide a method of forming a water repelling film whereby a water repelling film can be manufactured inexpensively, without requiring a plasma polymerization apparatus including an expensive thermal evaporator.

Since the speed of thermal evaporation by a thermal evaporator is instable, then the present embodiment which does not require thermal evaporation is favorable in terms of the reproducibility of film formation also.

Furthermore, in this water repelling film, the OH groups create strong bonds with the silane coupling water repelling material by employing the underlying siloxane film which retains hydrophobic substituent groups, and since these hydrophobic substituent groups impart ink resisting properties, then it is also possible to impart ink resistance in comparison with a conventional SiO₂ material.

In the present invention, desirably, the hydrophobic substituent group (hydrophobic group) is a methyl group. In the present invention, this group may be a hydrophobic group having a benzene ring, such as an alkyl group or phenyl group, but if the group is CH₃, then the thin film forming step can be carried out easily and inexpensively.

Furthermore, a water repelling film formed by the present invention can be suitably provided on a nozzle plate of an inkjet head. Since the water repelling film does not peel away and ink can be prevented from adhering to the surface of the nozzle plate, then it is possible to improve ejection performance.

### PRACTICAL EXAMPLES

### Sample 1

An SiOC film was manufactured by a cat-CVD method.

A mixed gas of monomethyl silane (CH₃SiH₃) and oxygen was introduced into a chamber.

The temperature of a tungsten wire, which served as a catalyst, was 1600° C.

When the sample was measured by FT-IR, a peak corresponding to Si—O was observed in the region of 1080 cm⁻¹ to 1100 cm⁻¹ and a peak corresponding to Si—CH₃ was observed between 1200 cm⁻¹ and 1300 cm⁻¹.

The angle of contact of pure water on this film was 47°.

### Sample 2

An SiOC film was manufactured by an application method.

A coating liquid, ULKS Ver. 3 made by Ulvac, was applied by spin coating onto a substrate and calcined at 350° C.

When the sample was measured by FT-IR, a peak corresponding to Si—O was observed in the region of 1080 cm⁻¹ to 1100 cm⁻¹ and a peak corresponding to Si—CH₃ was observed between 1200 cm⁻¹ and 1300 cm⁻¹.

The angle of contact of pure water on this film was 98°.

The samples 1 and 2 were irradiated with a PM 1102-3 low-voltage mercury lamp (17 mW/cm²) made by SEN LIGHTS CORPORATION, thereby leaving hydrophobic substituent groups and causing OH groups to be present.

Thereupon, a water repelling film was formed by vapor deposition of Optool DSX made by Daikin, in a vapor deposition apparatus. However, in the present invention, the method of film formation is not limited to vapor deposition and it is possible to prepare a coating liquid by dissolving a silane coupling agent in toluene to a ratio of 0.1 wt %, and to form the water repelling film by dip coating, or by spin coating by dripping the solution in a spin coater.

When these water repelling films were evaluated, it was seen that strong water repelling films having good reproducibility were obtained.

Consequently, it was seen that, according to the present invention, it is possible to manufacture a water repelling film which is strong and has good reproducibility, without requiring an expensive plasma polymerization apparatus having a thermal evaporator.

It should be understood that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A method of forming a water repelling film, the method comprising:
a thin film forming step of forming, on a base member, a thin film mainly having Si—O bonds and having hydrophobic substituent groups directly bonded to silicon, using a starting material which is a gas at normal temperature and atmospheric pressure;
an irradiation step of irradiating the thin film obtained in the thin film forming step with excitation light in such a manner that the hydrophobic substituent groups are left and OH groups are present in the thin film; and
an application step of applying a silane coupling agent onto the thin film obtained in the irradiation step.

2. The method of forming a water repelling film as defined in claim 1, wherein in the thin film forming step, cat-CVD or plasma CVD is carried out.

3. A method of forming a water repelling film, the method comprising:
a thin film forming step of forming, on a base member, a thin film mainly having Si—O bonds and having hydrophobic substituent groups directly bonded to silicon, by applying the thin film onto the base member followed by calcination;
an irradiation step of irradiating the thin film obtained in the thin film forming step with excitation light in such a manner that the hydrophobic substituent groups are left and OH groups are present in the thin film; and
an application step of applying a silane coupling agent onto the thin film obtained in the irradiation step.

4. The method of forming a water repelling film as defined in claim 1, wherein the hydrophobic substituent groups are each a methyl group.

5. The method of forming a water repelling film as defined in claim 3, wherein the hydrophobic substituent groups are each a methyl group.

6. The method of forming a water repelling film as defined in claim 1, wherein a material of the base member is any one of silicon, glass, metal, ceramic and polymer film.

7. The method of forming a water repelling film as defined in claim 3, wherein a material of the base member is any one of silicon, glass, metal, ceramic and polymer film.

8. The method of forming a water repelling film as defined in claim 1, wherein the excitation light is ultraviolet light or plasma.

9. The method of forming a water repelling film as defined in claim 3, wherein the excitation light is ultraviolet light or plasma.

10. A water repelling film formed by the method of forming a water repelling film as defined in claim 1.

11. A water repelling film formed by the method of forming a water repelling film as defined in claim 3.

12. A nozzle plate of an inkjet head formed with the water repelling film as defined in claim 10.

13. A nozzle plate of an inkjet head formed with the water repelling film as defined in claim 11.
